(19) United States
(12) Patent Application Publication
(10) Pub. No.: US 2024/0149993 A1
(43) Pub. Date: May 9, 2024

(54) INTEGRATED CONDITION MONITORING SYSTEM AND METHOD FOR ICE-GOING VESSELS

(71) Applicant: KOREA INSTITUTE OF OCEAN SCIENCE & TECHNOLOGY, Busan (KR)

(72) Inventors: Seong-Yeob JEONG, Daejeon (KR); Eun-Jin OH, Daejeon (KR); Jung-Seok HA, Daejeon (KR); Jin-Ho JANG, Daejeon (KR)

(21) Appl. No.: 18/066,949

(22) Filed: Dec. 15, 2022

(30) Foreign Application Priority Data
Nov. 4, 2022 (KR) 10-2022-0145975

(51) Int. Cl. B63B 79/10; G06T 7/60; G06V 20/50

(52) U.S. Cl. CPC B63B 79/10; G06T 7/60; G06V 20/50; B63B 2211/06

(57) ABSTRACT

An objective of the present disclosure is to provide an integrated condition monitoring system and method for an ice-going vessel, the system and method for acquiring voyage information and environment information when a vessel sails a polar ocean area.

In order to achieve the objective, an integrated condition monitoring system for an ice-going vessel includes: imaging units installed at a bow, a stern, and left and right sides of the vessel, and imaging an ice environment; and a server monitoring an integrated condition of the vessel on the basis of images taken by the imaging units.

### CROSS REFERENCE TO RELATED APPLICATION

The present application claims priority to Korean Patent Application No. 10-2022-0145975 filed on Nov. 4, 2022, the entire contents of which is incorporated herein for all purposes by this reference.

### BACKGROUND OF THE INVENTION

### Field of the Invention

The present disclosure relates to an integrated condition monitoring system and method for an ice-going vessel, particularly, an integrated condition monitoring system and method for an ice-going vessel, the system and method for acquiring voyage information and environment information when a vessel sails a polar ocean area.

### Description of the Related Art

According to National Snow and Ice Data Center, the sea ice area of the North Pole on Aug. 15, 2018 is 5.7 million km², which is larger than that in 2012, but has been decreased by 1.58 million km² from the average sea ice area from 1981 to 2010, and the sea ice area is generally decreasing.

Such reduction of the sea ice area of the North Pole considerably influences the earth environment system, but may result in demands of new ice-breaking vessels or polar offshore plants with opening of arctic sailing routes in the summertime in terms of ship construction/ocean industry, so it provides new opportunities.

In particular, with the effectuation of Polar Code from January, 2017, all new constructed vessels are under control of Polar Code, so an interest in safety of ice-going vessels is also increased and winterization is also considered as a very important factor in terms of designing and operating of vessels.

In general, arctic vessels, for example, a large-scale freight vessel sailing through a polar region or an ice breaker that tows vessels in distress in a polar region or performs polar exploration are sailed in a severe polar environment.

Recently, developing arctic sailing routes is being realized in order to reduce sailing routes and it is expected that large-scale vessels that are supposed to sail arctic sailing routes will be increasingly developed and ordered.

Integrated condition monitoring systems for vessels in the related art include technologies about traffic control, recognition and control of dangerous conditions in vessels, monitoring of fuel and freight, checking of the condition of a propelling system, remote control, etc. on the sea.

Further, integrated condition monitoring systems for vessels in the related art include functions of controlling traffic of vessels and monitoring a fire, managing voyage information of a vessel, monitoring facilities in a vessel, automating control, etc.

However, such systems do not include matters about a method of analyzing an ice environment for vessels sailing a frozen ocean area, a method of calculating an ice load that is applied to a hull, a procedure of evaluating ice performance, etc., so there is a problem that it is difficult to use the system in order to evaluate the general ice performance of a vessel, and support safety sailing of a vessel and maintain a vessel in a frozen ocean area.

### PRIOR ART DOCUMENT

### Patent Document

Korean Patent No. 10-1880815

### SUMMARY OF THE INVENTION

In order to solve the problems described above in the related art, an objective of the present disclosure is to provide an integrated condition monitoring system and method for an ice-going vessel, the system and method for acquiring voyage information and environment information when a vessel sails a polar ocean area.

In order to achieve the objective, an integrated condition monitoring system for an ice-going vessel includes: imaging units installed at a bow, a stern, and left and right sides of the vessel, and imaging an ice environment; and a server monitoring an integrated condition of the vessel on the basis of images taken by the imaging units.

Further, in the integrated condition monitoring system for an ice-going vessel according to the present disclosure, the server includes a data collector finding out the ice environment from the images through image analysis, and acquiring voyage information through data of a voyage data recorder (VDR) and an alarm monitoring system (AMS) of the vessel under a condition of the ice environment.

Further, in the integrated condition monitoring system for an ice-going vessel according to the present disclosure, the data collector includes: a 3-axis strain gauge sensor mounted on a parallel part of the bow and the hull of the vessel, and a frame and the internal plate of the hull in a stern area to measure a hull strain; and an angular acceleration sensor being able to measure motion characteristics at a center of gravity of the hull, and the 3-axis strain gauge sensor and the angular acceleration sensor measure a hull strain and motion characteristics of the vessel.

Further, in the integrated condition monitoring system for an ice-going vessel according to the present disclosure, the server includes a data classifier classifying measured data into structured data and unstructured data for data framing.

Further, in the integrated condition monitoring system for an ice-going vessel according to the present disclosure, the server includes a data analyzer searching for abnormal data and missing data through data analysis.

Further, in the integrated condition monitoring system for an ice-going vessel according to the present disclosure, the server includes a data learner performing spatio-temporal analysis on measured data and performing interpolation on a missing data region through learning using an artificial intelligence model when data have a problem or are missing.

Further, in the integrated condition monitoring system for an ice-going vessel according to the present disclosure, the server includes a database unit constructing a database using the interpolated data.

Further, in the integrated condition monitoring system for an ice-going vessel according to the present disclosure, the server includes a performance evaluator evaluating performance of the vessel by analyzing a local ice load, a global ice load, or ice performance using a database.

Further, in the integrated condition monitoring system for an ice-going vessel according to the present disclosure, the local ice load is calculated by measuring the hull strain.

Further, in the integrated condition monitoring system for an ice-going vessel according to the present disclosure, the global ice load is calculated by measuring motion characteristics of the vessel.

Meanwhile, in order to achieve the objective, an integrated condition monitoring method for an ice-going vessel includes: a first step of imaging an ice environment by means of imaging units installed at a bow, a stern, and the left and right sides of a vessel; a second step of finding out an ice environment by analyzing collected images and acquiring voyage information from data in a voyage data recorder (VDR) and an alarm monitoring system (AMS) of the vessel under the condition of the ice environment by means of a data collector; a third step of classifying measured data into structured data or unstructured data for data framing by means of a data classifier; a fourth step of searching for abnormal data or missing data by means of a data analyzer; a fifth step of performing spatio-temporal analysis on measured data and performing interpolation on a missing data region through learning using an artificial intelligence model when data have a problem or are missing by means of a data learner; a sixth step of constructing a database using interpolated data by means of a database unit; and a seventh step of evaluating performance of the vessel by analyzing a local ice load, a global ice load, or ice performance using the database by means of a performance evaluator.

Further, in the integrated condition monitoring method for an ice-going vessel according to the present disclosure, the data collector includes: a 3-axis strain gauge sensor mounted on a parallel part of the bow and the hull of the vessel, and a frame and the internal plate of the hull in a stern area to measure a hull strain; and an angular acceleration sensor being able to measure motion characteristics at a center of gravity of the hull, and the 3-axis strain gauge sensor and the angular acceleration sensor measure a hull strain and motion characteristics of the vessel.

Further, in the integrated condition monitoring method for an ice-going vessel according to the present disclosure, the data collector determines a sea ice concentration as an ice environment, analyzes the thickness of sea ice through an ice piece image rotated in ice breaking, and performs measurement by transmitting a trigger signal when the ice thickness is 30 cm or more and the concentration is 60% or more as the result of analysis.

Further, in the integrated condition monitoring method for an ice-going vessel according to the present disclosure, when the trigger signal is transmitted, the data collector extracts information of a location and a speed of the vessel, a heading angle, a draft condition, engine power, a propeller revolution, and a propelling system angle, by cooperating with the voyage data recorder (VDR) and the alarm monitoring system (AMS).

Further, in the integrated condition monitoring method for an ice-going vessel according to the present disclosure, the performance evaluator calculates the local ice load applied in a local area of the hull using an influence coefficient method on the basis of information of a hull strain in the hull in ice breaking, and calculates the global ice load applied to the vessel through motion analysis using motion characteristic measurement data of the vessel in ice breaking.

Further, in the integrated condition monitoring method for an ice-going vessel according to the present disclosure, the performance evaluator extracts data for a predetermined period from one or more of a heading angle, a draft condition, engine power, a propeller revolution, and a propelling system angle through analysis of coefficient of variation (CV) on the basis of voyage information acquired from the information of the voyage data recorder (VDR) and the alarm monitoring system (AMS) of the vessel, and then calculates ice resistance applied to the vessel in ice breaking using Work-Energy Law and Newton's Second Law.

Meanwhile, in order to achieve the objectives, the integrated condition monitoring system for an ice-going vessel according to the present disclosure is monitored by the integrated condition monitoring method for an ice-going vessel.

Details of other embodiments are included in detailed description of the invention” and the accompanying “drawings”.

The advantages and/or features of the present disclosure, and methods of achieving them will be clear by referring to the exemplary embodiments that will be describe hereafter in detail with reference to the accompanying drawings.

However, it should be noted that the present disclosure is not limited to the configuration of each of embodiments to be described hereafter and may be implemented in various ways, and the exemplary embodiments described in the specification are provided to complete the description of the present disclosure and let those skilled in the art completely know the scope of the present disclosure and the present disclosure is defined by claims.

According to the present disclosure described above, there is an effect that it is possible to acquire voyage information and environment information when a vessel sails a polar ocean area through the integrated condition monitoring system for an ice-going vessel and an ice performance analysis method.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is a conceptual diagram showing the concept of an integrated condition monitoring system and method for an ice-going vessel according to the present disclosure;

FIG. 2 is a block diagram showing the entire configuration of an integrated condition monitoring system for an ice-going vessel according to the present disclosure;

FIG. 3 is a block diagram showing the configuration of a server in the integrated condition monitoring system for an ice-going vessel according to the present disclosure;

FIG. 4 is a flowchart showing the entire flow of a method of analyzing ice performance according to the present disclosure;

FIG. 5 is a view showing a process of calculating a local ice load in the method of analyzing ice performance according to the present disclosure;

FIG. 6a˜6f are a view showing a process of calculating a global ice load in the method of analyzing ice performance according to the present disclosure;

FIG. 7a˜7f are a view showing a method of estimating ice resistance on a vessel in the method of analyzing ice performance according to the present disclosure; and

FIG. 8 is a view showing a method of estimating an ice performance result of a vessel in the method of analyzing ice performance according to the present disclosure.

### DETAILED DESCRIPTION OF THE INVENTION

Before describing the present disclosure in detail, terms or words used herein should not be construed as being limited to common or dictionary meanings, the concepts of various terms may be appropriately defined to the most optimally describe the disclosure by the inventor(s), and it should be noted that those terms or words should be construed as meanings and concepts corresponding to the technical spirit of the present disclosure.

That is, it should be noted that the terms used herein are used only to describing preferred embodiments of the present disclosure, not intending to limit the present disclosure in detail, and those terms are terms defined in consideration of various possibilities of the present disclosure.

Further, it should be noted that, in the specification, singular expression may include plural expression unless clearly stated in the sentences, and includes a singular meaning even if it is similarly expressed as a plural number.

It should be noted that when a component is described as “including” another component throughout the specification, the component may further include another component without another component excluded, unless specifically stated otherwise.

Further, it should be noted that when a component is described as “exists in” and “is connected to” another component, the component may be directly connected with another component, may be installed in contact with another component, or may be installed with a predetermined gap. When the component is installed with a gap, there may be a third component or means for fixing and connecting the component to another component, and the third component or means may not be described.

On the other hands, it should be understood that when a component is described as “directly connected” or “indirectly connected” to another component, it should be construed as there is no third component or means.

Similarly, the terms used herein to describe a relationship between elements, that is, “between”, “directly between”, “adjacent” or “directly adjacent” should be interpreted in the same manner as those described above.

Further, in the specification, it should be noted that terms such as “first side”, “second side”, “first”, and “second”, if used, are used to clearly discriminate one components from another component and the meaning of the corresponding component is not limited by the terms.

Further, terms related to positions such as “up”, “down”, “left”, and “right”, if used herein, should be construed as indicating relative positions of corresponding components in the corresponding figures and should not be construed as stating absolute positions unless the absolute positions of them are specified.

Further, in the specification, when components are given reference numerals, the same reference numerals are given to same components even if they are shown in different figures, that is, same reference numerals indicate same components throughout the specification.

The size, position, coupling relationship, etc. of components of the present disclosure may be partially exaggerated or reduced in the accompanying drawings for the convenience of description in order to sufficiently and clearly transmit the spirit of the present disclosure, so the proportion or scale may not be precise.

Further, in the following description of the present disclosure, components that are determined to unclearly make the spirit of the present disclosure unclear, for example, well-known technology including the related art may not be described in detail.

Hereafter, embodiments of the present disclosure are described in detail with reference to relevant drawings.

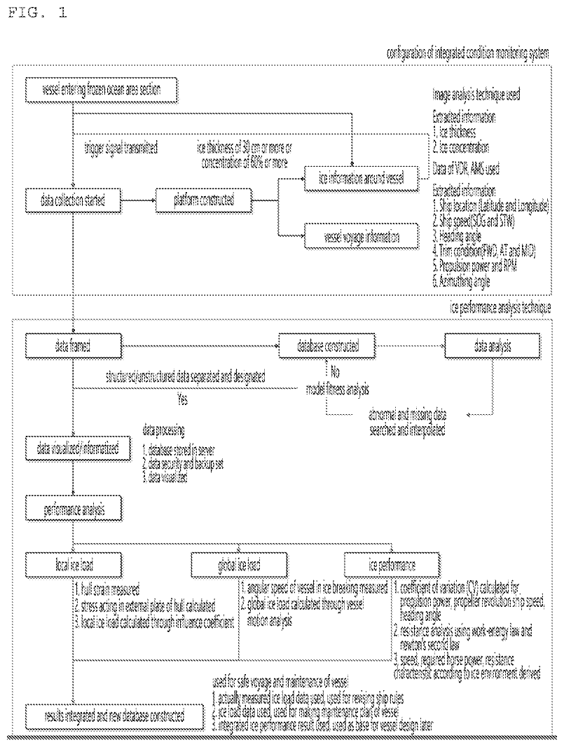

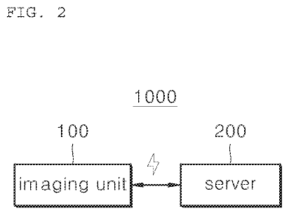

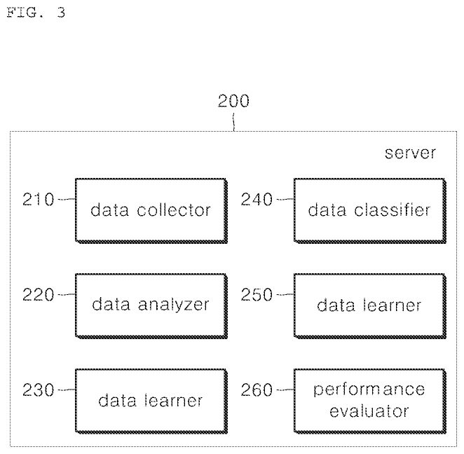

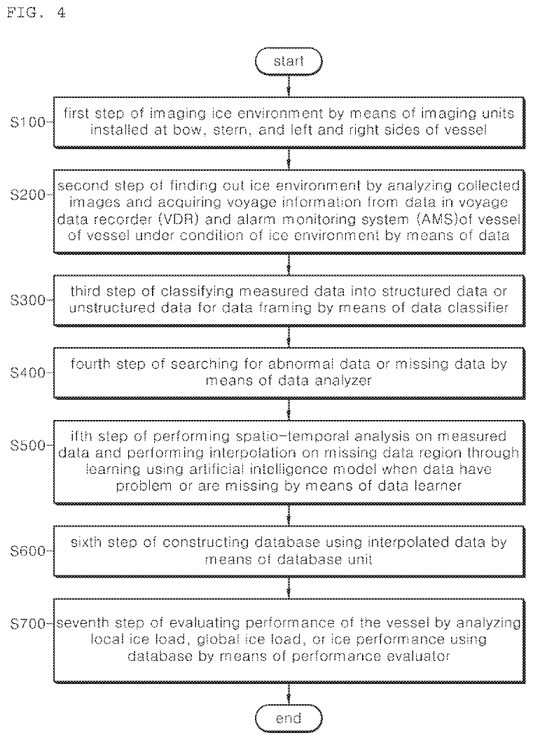

FIG. 1 is a conceptual diagram showing the concept of an integrated condition monitoring system and method for an ice-going vessel according to the present disclosure and FIG. 2 is a block diagram showing the entire configuration of an integrated condition monitoring system for an ice-going vessel according to the present disclosure.

Referring to FIGS. 1 and 2, an integrated condition monitoring system 1000 for an ice-going vessel according to the present disclosure includes an imaging unit 100 and a server 200.

The imaging unit 100 is installed at the bow, stern, and left and right sides of a vessel and images an ice environment.

The server 200 monitors the integrated condition of the vessel on the basis of the images taken by the imaging unit 100.

This is described in more detail with reference to FIGS. 3 to 8.

FIG. 3 is a block diagram showing the configuration of a server in the integrated condition monitoring system for an ice-going vessel according to the present disclosure.

Referring to FIG. 3, in the integrated condition monitoring system 1000 for an ice-going vessel according to the present disclosure, the server 200 includes a data collector 210, a data classifier 220, a data analyzer 230, a data learner 240, a database unit 250, and a performance evaluator 260.

The data collector 210 finds out an ice environment from images taken by the imaging unit 100 through image analysis and acquires voyage information from data in a voyage data recorder (VDR) and an alarm monitoring system (AMS) of the vessel under the condition of the ice environment.

The data collector 210 includes a 3-axis strain gauge sensor and an angular acceleration sensor.

The 3-axis strain gauge sensor is mounted on a parallel part of the bow and the hull of the vessel, and a frame and the internal plate of the hull in the stern area, and measures a hull strain.

The angular acceleration sensor is mounted at the center of gravity of the hull and can measure motion characteristics.

Accordingly, the -axis strain gauge sensor and the angular acceleration sensor of the data collector 210 measure a hull strain and motion characteristics of the vessel in ice breaking.

The data classifier 220 classifies measured data into structured data or unstructured data for data framing.

The data analyzer 230 searches for abnormal data or missing data through data analysis.

When data have a problem or are missing, the data learner 240 performs spatio-temporal analysis on measured data and performs interpolation on a missing data region through learning using an artificial intelligence model.

In more detail, when measured data have a problem or are missing, a clustering result of measured data is visualized through Dendrogram by applying a hierarchical clustering technique of time-series clustering, and missing value is replaced using mean imputation through an alternative cluster composed of sensors having data distribution similar to that of a missing sensor.

In this case, when hierarchical clustering analysis is performed, python is used and a clustering result is visualized through Dendrogram.

The database unit 250 constructs a database using interpolated data.

The performance evaluator 260 evaluates the performance of the vessel by analyzing a local ice load, a global ice load, or ice performance using the database.

In other words, when a vessel enters an ice sea section, an ice environment (e.g., an ice thickness, an ice concentration, etc.) is found out using an image analysis technique on the basis of images taken by the imaging units 100 installed at the bow, stern, and left and right sides of the vessel, and the data collector 210 acquires or measures voyage information through data of the voyage data recorder (VDR) or the alarm monitoring system (AMS) of the vessel under the ice environment condition.

In this case, the imaging unit 100, for example, may include a network camera, etc.

Further, the ice environment around a vessel that is extracted using an image analysis technique may include an ice thickness, an ice concentration, etc.

Further, the vessel voyage information that is acquired or measured may include information of the location and speed of the vessel, the heading angle, a draft condition, engine power, a propeller revolution, a propelling system angle, etc.

Thereafter, for data framing of the acquired or measured data, the data classifier 220 classifies the acquired or measured data into structured data or unstructured data.

The data analyzer 230 analyzes the classified data, and when data have a problem or are missing as the result of analysis, the data learner 240 performs spatio-temporal analysis on the measured data and performs interpolation on the missing data region through learning using an artificial intelligence model.

The interpolated data are constructed into a database through the database unit 250.

The performance evaluator 260 can more accurately evaluate the performance of the vessel through analysis of local ice load, global ice load, and ice performance using the constructed database, examine availability of a design ice load formula, which is provided under ship rules, on the basis of the result of evaluating performance according to an ice environment and a voyage environment, secure actually measured data for structure design, and improve safety and maintenance function of the vessel when sailing a frozen ocean area.

Meanwhile, in order to construct the integrated condition monitoring system for an ice-going vessel that sails a polar ocean area, a 3-axis strain gauge sensor for measuring a hull strain is attached to a parallel part of a bow and a hull, a frame and the internal plate of the hull in the stern area, and an angular acceleration sensor that can measure motion characteristics is installed at the center of gravity of the hull, whereby motion characteristics of the vessel in ice breaking are measured.

Further, an interface is constructed by coupling a system for acquiring a hull strain and angular acceleration data to an inter-vessel network so that information can be extracted from the voyage data recorder (VDR) and the alarm monitoring system (AMS) of the vessel, and measured data are stoned in the forma to ASCII.

A 4K-class network camera system is installed at the bow, the stern, and the left and right sides of the vessel, whereby image information about an ice environment around the vessel is acquired, and images to be used for image analysis are backed up through downscaling into an FHD-class image quality.

Further, a data platform is constructed to that measured data and image data can be synchronized under UTC and stored in a measurement folder.

Meanwhile, the performance evaluator 260 calculates a local ice load by measuring a hull strain.

Further, the performance evaluator 260 calculates a global ice load by measuring the motion characteristics of the vessel.

This will be described in more detail later.

Meanwhile, the integrated condition monitoring system for an ice-going vessel according to the present disclosure is monitored by an integrated condition monitoring method for an ice-going vessel.

FIG. 4 is a flowchart showing the entire flow of a method of analyzing ice performance according to the present disclosure.

Referring to FIG. 4, an integrated condition monitoring method for an ice-going vessel according to the present disclosure includes seven steps.

In particular, the integrated condition monitoring method for an ice-going vessel according to the present disclosure is characterized in an ice performance analysis technique.

In a first step S100, the imaging units 100 installed at the bow, the stern, and the left and right sides of a vessel images an ice environment.

In a second step S200, the data collector 210 finds out an ice environment from collected images through image analysis and acquires voyage information from data in a voyage data recorder (VDR) and an alarm monitoring system (AMS) of the vessel under the condition of the ice environment.

In a third step S300, the data classifier 220 classifies measured data into structured data or unstructured data for data framing.

In a fourth step S400, the data analyzer 230 searches for abnormal data or missing data.

In a fifth step S500, when data have a problem or are missing, the data learner 240 performs spatio-temporal analysis on measured data and performs interpolation on a missing data region through learning using an artificial intelligence model.

In a sixth step S600, the database unit 250 constructs a database using the interpolated data.

In a seventh step S700, the performance evaluator 260 evaluates performance of the vessel by analyzing a local ice load, a global ice load, or ice performance using the database.

As described above, in the integrated condition monitoring method for an ice-going vessel according to the present disclosure, the data collector 210 includes a 3-axis strain gauge sensor mounted on a parallel part of the bow and the hull of the vessel, and a frame and the internal plate of the hull in the stern area to measure a hull strain, and an angular acceleration sensor mounted at the center of gravity of the hull and being able to measure motion characteristics.

The 3-axis strain gauge sensor and the angular acceleration sensor measure a hull strain and motion characteristics of the vessel in ice breaking.

In particular, in the integrated condition monitoring method for an ice-going vessel according to the present disclosure, the data collector 210 determines a sea ice concentration as an ice environment, analyzes the thickness of sea ice through an ice piece image rotated in ice breaking, and performs measurement by transmitting a trigger signal when the ice thickness is 30 cm or more and the concentration is 60% or more as the result of analysis.

Further, when the trigger signal is transmitted, the data collector 210 extracts information of the location and speed of the vessel, the heading angle, a draft condition, engine power, a propeller revolution, a propelling system angle, etc. by cooperating with the voyage data recorder (VDR) and the alarm monitoring system (AMS).

Meanwhile, in the integrated condition monitoring method for an ice-going vessel according to the present disclosure, the performance evaluator 260 calculates a local ice load that is applied to a local area of the hull using an influence coefficient method on the basis of the information of a hull strain applied in the hull in ice breaking, and calculates a global ice load that is applied to the vessel through motion analysis using motion characteristic measurement data of the vessel in ice breaking.

Further, the performance evaluator 260 extracts data for a predetermined period from one or more of the heading angle, a draft condition, engine power, a propeller revolution, and a propelling system angle through analysis of coefficient of variation (CV) on the basis of voyage information acquired from the information of the voyage data recorder (VDR) and the alarm monitoring system (AMS) of the vessel, and then calculates ice resistance applied to the vessel in ice breaking using Work-Energy Law and Newton's Second Law.

In other words, an image analysis technique is used on the basis of image data obtained through network cameras installed at the bridge, bow, stern, and left and right sides of the vessel, the concentration of sea ice is determined through binarization, the thickness of the sea ice is analyzed through an ice piece image rotated in ice breaking, and a trigger signal is transmitted to a measuring system and measurement is started when the ice thickness is 30 cm or more or the concentration is 60% or more.

The measuring system may be the data collector 210 including a 3-axis strain gauge sensor and an angular acceleration sensor.

In particular, the concentration and thickness of sea ice are obtained using image data taken until the measuring system is stopped, a frequency table is constructed using data extracted for a measurement time, and average ice thickness and concentration are calculated from the frequency table.

When the trigger signal is transmitted to the measuring system, the location and speed of the vessel, the heading angle, a draft condition, engine power, a propeller revolution, a propelling system angle, etc. are extracted in cooperation with the voyage data recorder (VDR) and the alarm monitoring system (AMS) and are stored in the form of a single file through synchronization with ice information calculated previously.

After stored in the form of a single file, the image data are classified into unstructured data and stored in a video folder, and the ice information and the voyage information are classified into structured data and constructed into a database in the database unit 250.

When the database is constructed in the database unit 250, whether measured data have a problem or are missing is determined through a data analysis process, and when data are missing, spatio-temporal analysis is performed on the measured data and interpolation is performed on the mission data region by learning through an artificial intelligence model, whereby the database is reconstructed.

Thereafter, a database is completed, data visualizing and data indexing functions for the measured data are activated using a big data technology, and interested region data are extracted, thereby performing performance analysis.

In the performance analysis process, an ice load that is applied in a local region of the hull is calculated using an influence coefficient method on the basis of the information of a hull strain applied in the hull in ice breaking, and a global ice load applied to the vessel is calculated through motion analysis using motion characteristic measurement data of the vessel in ice breaking.

Further, data for a predetermined period for which the heading angle, a draft condition, engine power, a propeller revolution, a propelling system angle, etc. are constant are extracted through analysis of coefficient of variation (CV) on the basis of voyage information acquired from the voyage data recorder (VDR) and the alarm monitoring system (AMS) of the vessel, and then ice resistance applied to the vessel in ice breaking is calculated using Work-Energy Law and Newton's Second Law.

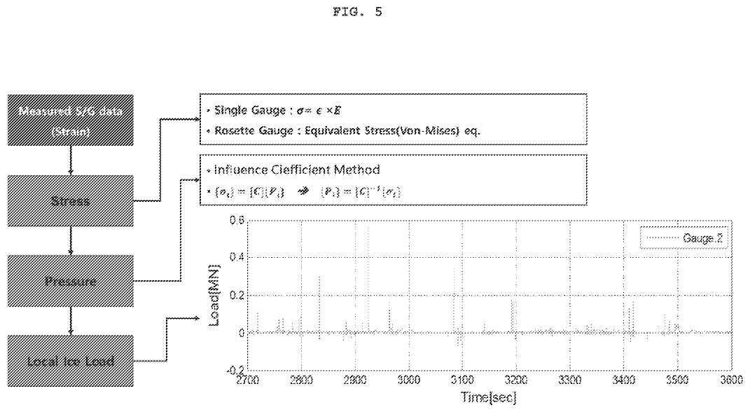

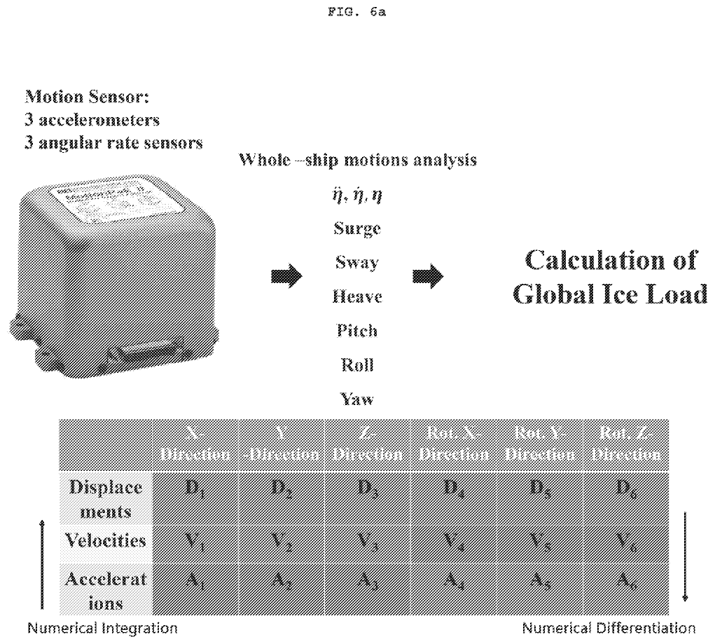

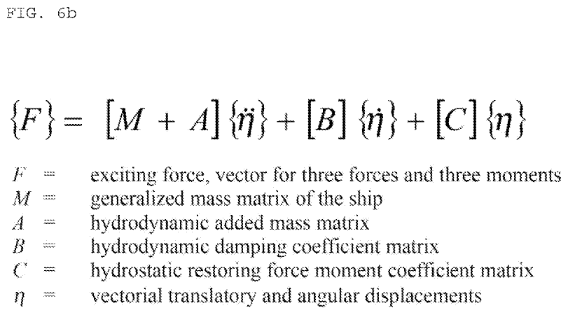

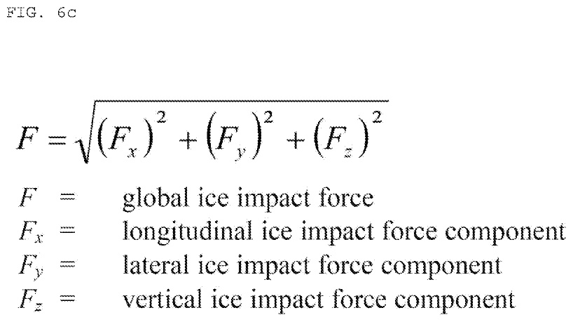

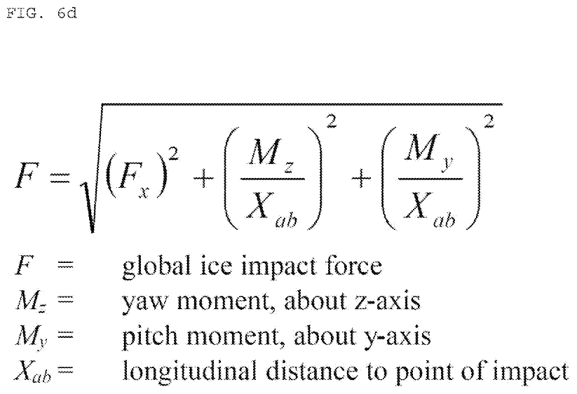

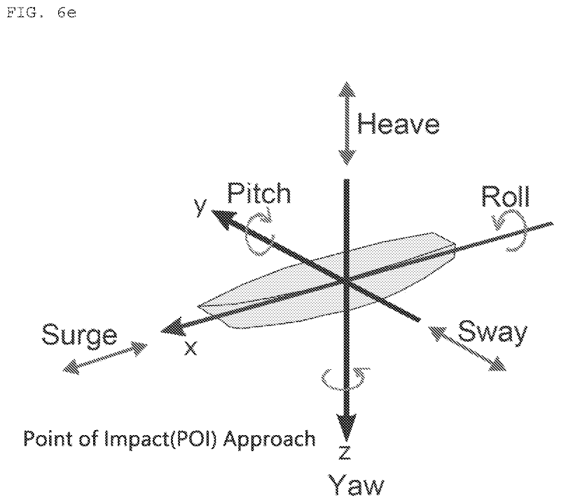

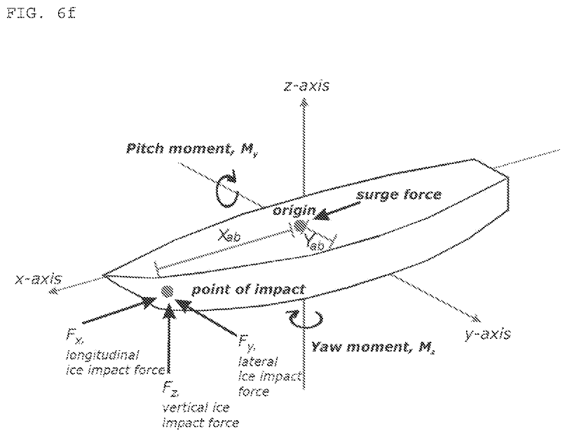

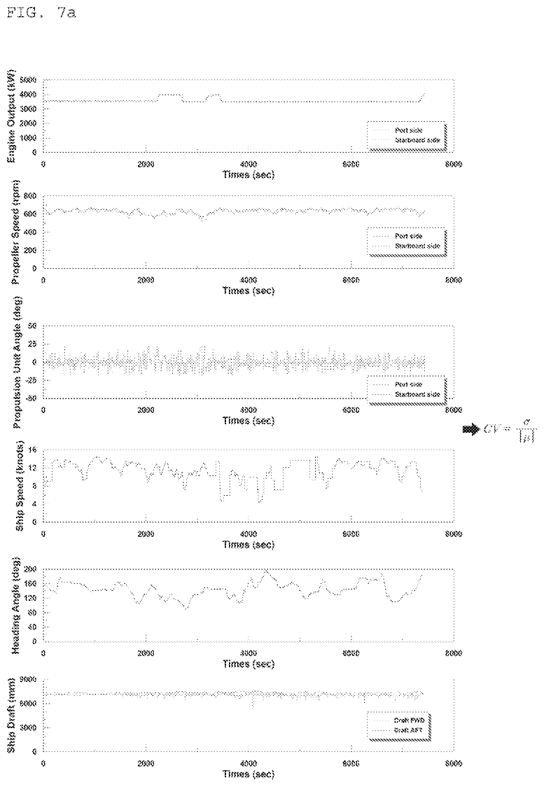

FIG. 5 is a view showing a process of calculating a local ice load in the method of analyzing ice performance according to the present disclosure.

Referring to FIG. 5, a method of calculating a local ice load by measuring a hull strain is as follows.

Assuming that deformation of a structure member, that is, the hull is elastic, it is possible to convert data of hull strain E measured while an ice breaker sails while breaking ice in a frozen ocean area into hull stress a that is generated in the hull.

It is possible to convert the hull stress calculated in this way into local ice pressure P that is applied to the hull using an influence coefficient method, and an influence matrix C is obtained in a structure analysis process using a finite element method.

Accordingly, a local ice load applied to the outer plate of the bow by equivalent stress acting in the regions in which gauges are attached is calculated from gauge strain data using an influence coefficient method.

For reference, a 3-axis rosette gauge calculates principle strains .ϵ₁ and .ϵ₂ using strains .ϵ_{A}, ϵ_{B}, and .ϵ_{C} in three directions (an x axis in the front-rear direction of the hull, a y axis in the depth direction of the hull, and a z axis in a 45° direction) obtained from a strain gauge, and when it is assumed that it is a planar stress state, the 3-axis rosette gauge can convert the planar stress into principle stress and von Mises equivalent stress.

$$where , {ϵ}_{1} = \frac{1}{2} ( {ϵ}_{a} + {ϵ}_{c} ) + \frac{1}{2} \sqrt{{( {ϵ}_{a} - {ϵ}_{c} )}^{2} + {( {ϵ}_{a} - 2 {ϵ}_{b} + {ϵ}_{c} )}^{2}} and \\ {ϵ}_{2} = \frac{1}{2} ( {ϵ}_{a} + {ϵ}_{c} ) - \frac{1}{2} \sqrt{{( {ϵ}_{a} - {ϵ}_{c} )}^{2} + {( {ϵ}_{a} - 2 {ϵ}_{b} + {ϵ}_{c} )}^{2}} . \\ {σ}_{1} = \frac{E}{2 ( 1 - v )} ( {ϵ}_{A} + {ϵ}_{B} ) + \frac{E \sqrt{2}}{2 ( 1 + v )} \sqrt{{( {ϵ}_{A} - {ϵ}_{C} )}^{2} + {( {ϵ}_{B} - {ϵ}_{C} )}^{2}} , \\ {σ}_{2} = \frac{E}{2 ( 1 - v )} ( {ϵ}_{A} + {ϵ}_{B} ) - \frac{E \sqrt{2}}{2 ( 1 + v )} \sqrt{{( {ϵ}_{A} - {ϵ}_{C} )}^{2} + {( {ϵ}_{B} - {ϵ}_{C} )}^{2}} , and {σ}_{v} = \sqrt{{σ}_{1}^{2} + {σ}_{2}^{2} - {σ}_{1} {σ}_{2}} .$$

FIG. 6a˜6f are a view showing a process of calculating a global ice load in the method of analyzing ice performance according to the present disclosure.

Referring to FIG. 6a˜6f, a method of calculating a global ice load by measuring motion characteristics of the vessel is as follows.

Acceleration components (surge, sway, heave) and angular speed components (pitch, roll, yaw) of a vessel in x, y, and z directions in ice breaking are measured using an angular acceleration sensor, and a motion equation about 6 degrees of freedom of the vessel is calculated on the basis of this information, whereby forces and moments in the x, y, and z directions applied to the vessel are calculated.

A global ice load applied to the vessel is calculated in terms of a ship's origin or a point of impact on the basis of the factors.

For reference, when a motion equation of 6 degrees of freedom of a vessel is calculated in terms of a ship's origin, it is possible to calculate force and moment components in the x, y, and z directions, and it is possible to calculate a global ice load applied to the vessel on the basis of the components.

That is, F={square root over (((F_{X})²+(F_{Y})²+(F_{Z})²))}, where F_{X}, F_{Y}, F_{Z} are external forces in respective directions.

In terms of a point of impact, since an angular acceleration sensor is installed close to the center of gravity of the vessel, sway that is a straight motion on the X axis at the point and heave that is a straight motion on the Y axis at the point may not be clearly shown in comparison to sway and heave at a point at which bow impact is generated.

Accordingly, it is possible to calculate force components that are applied perpendicular to the side of the vessel using even pitch and yaw moment values, and in this case, if it is possible to find out a point where impact is generated from the position at which the angular acceleration sensor is installed, it is possible to more accurately calculate an ice load.

Accordingly, a global ice load that is applied to a vessel can be expressed as follows.

That is,

$$F = \sqrt{{( {F}_{X} )}^{2} + {( \frac{{M}_{Z}}{{X}_{ab}} )}^{2} + {( \frac{{M}_{Y}}{{X}_{ab}} )}^{2}} ,$$

where X_{ab} is the distance from the position at which an angular acceleration sensor is installed to a point where impact is generated.

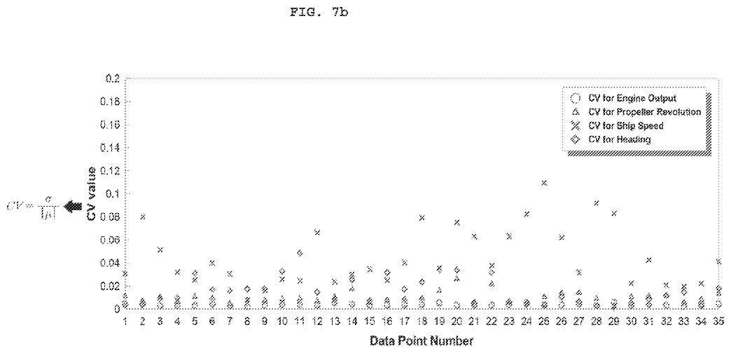

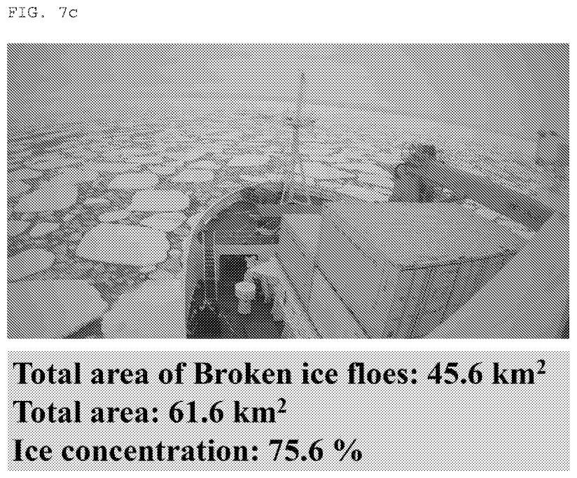

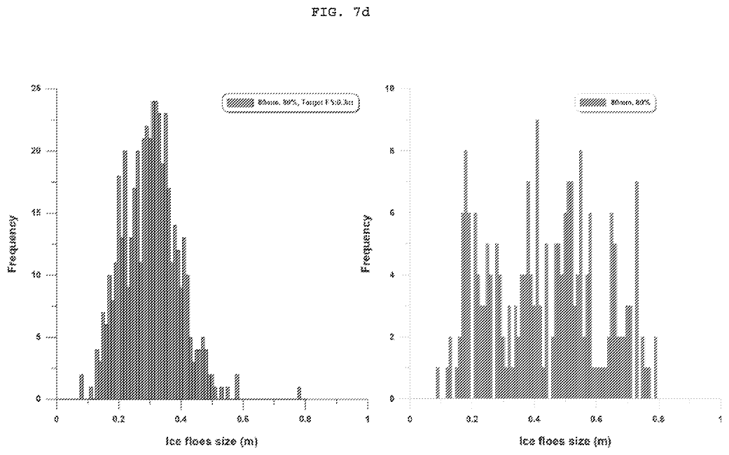

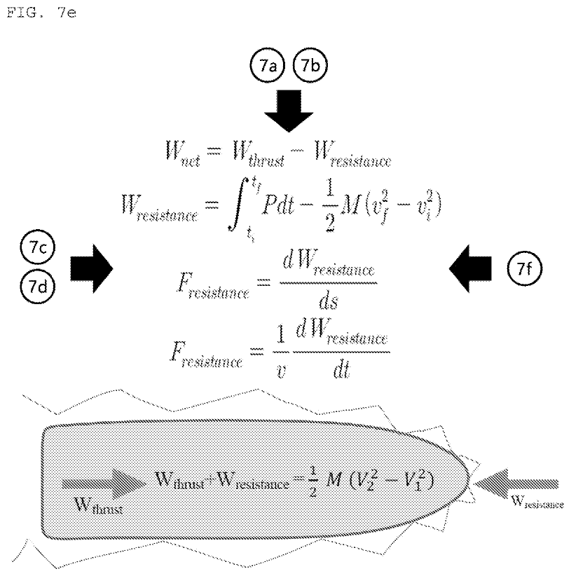

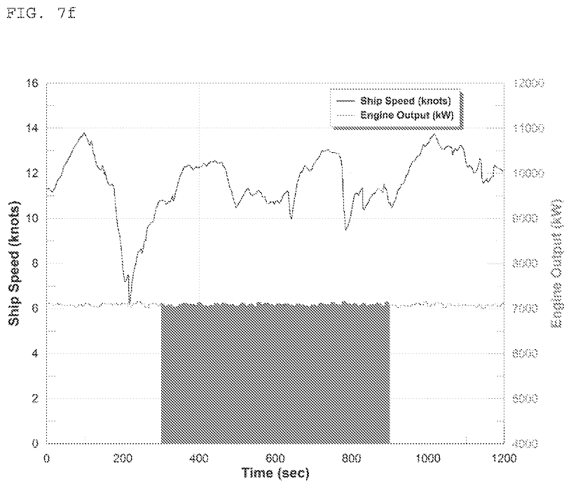

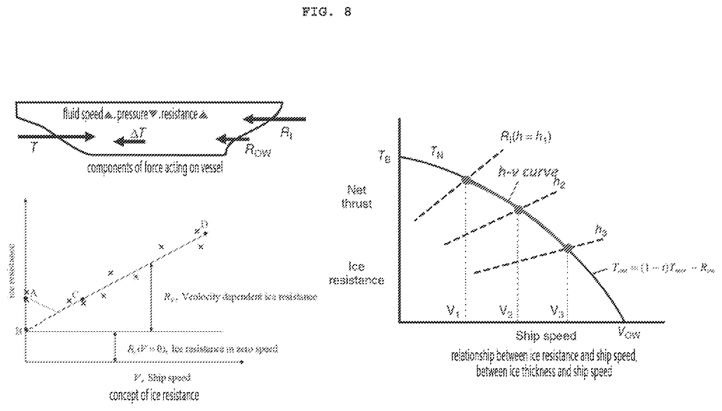

FIG. 7a˜7f are a view showing a method of estimating ice resistance on a vessel in the method of analyzing ice performance according to the present disclosure and FIG. 8 is a view showing a method of estimating an ice performance result of a vessel in the method of analyzing ice performance according to the present disclosure.

Referring to FIGS. 7a-7f and 8, thereafter, an available net thrust Tant of the vessel is calculated using a thrust reduction coefficient t, a thrust Tmcr under the condition of maximum continuous output, and row of the vessel, and an available voyage speed of the vessel (h-v curve) is derived through the relationship with ice resistance R_{I} at each speed of the vessel according to ice thicknesses h1, h2, and h3, whereby an ice performance result of the vessel according to an ice environment is derived.

Next, a new database is constructed by integrating a local ice load, a global ice load, a ship speed-ice resistance, a required horse power-ice resistance relationship of the vessel, and the new database can be used as fundamental data later for performance analysis, a safety voyage, and maintenance of the vessel.

According to the present disclosure described above, there is an effect that it is possible to acquire voyage information and environment information when a vessel sails a polar ocean area through the integrated condition monitoring system and method for an ice-going vessel.

Various preferred embodiments of the present disclosure were described above through some examples, but the various embodiments described in “detailed description of the invention” are only examples and it would be clearly understood by those skilled in the art the present disclosure may be changed in various ways or equivalently implemented from the above description.

Further, it should be noted that since the present disclosure may be implemented in other various ways, the present disclosure is not limited to the above description, the above description is provided to completely explain the present disclosure and provided only to completely inform those skilled in the art of the range of the present disclosure, and the present disclosure is defined by only claims.

What is claimed is:

1. An integrated condition monitoring system for an ice-going vessel, comprising:
imaging units installed at a bow, a stern, and left and right sides of the vessel, and imaging an ice environment; and
a server monitoring an integrated condition of the vessel on the basis of images taken by the imaging units.

2. The integrated condition monitoring system of claim 1, wherein the server includes a data collector finding out the ice environment from the images through image analysis, and acquiring voyage information through data of a voyage data recorder (VDR) and an alarm monitoring system (AMS) of the vessel under a condition of the ice environment.

3. The integrated condition monitoring system of claim 2, wherein the data collector includes:
a 3-axis strain gauge sensor mounted on a parallel part of the bow and the hull of the vessel, and a frame and the internal plate of a hull in a stern area to measure a hull strain; and
an angular acceleration sensor being able to measure motion characteristics at a center of gravity of the hull, and
the 3-axis strain gauge sensor and the angular acceleration sensor measure a hull strain and motion characteristics of the vessel.

4. The integrated condition monitoring system of claim 1, wherein the server includes a data classifier classifying measured data into structured data and unstructured data for data framing.

5. The integrated condition monitoring system of claim 1, wherein the server includes a data analyzer searching for abnormal data and missing data through data analysis.

6. The integrated condition monitoring system of claim 1, wherein the server includes a data learner performing spatio-temporal analysis on measured data and performing interpolation on a missing data region through learning using an artificial intelligence model when data have a problem or are missing.

7. The integrated condition monitoring system of claim 1, wherein the server includes a database unit constructing a database using the interpolated data.

8. The integrated condition monitoring system of claim 3, wherein the server includes a performance evaluator evaluating performance of the vessel by analyzing a local ice load, a global ice load, or ice performance using a database.

9. The integrated condition monitoring system of claim 8, wherein the local ice load is calculated by measuring the hull strain.

10. The integrated condition monitoring system of claim 8, wherein the global ice load is calculated by measuring motion characteristics of the vessel.

11. An integrated condition monitoring method for an ice-going vessel, comprising:
a first step of imaging an ice environment by means of imaging units installed at a bow, a stern, and the left and right sides of a vessel;
a second step of finding out an ice environment by analyzing collected images and acquiring voyage information from data in a voyage data recorder (VDR) and an alarm monitoring system (AMS) of the vessel under the condition of the ice environment by means of a data collector;
a third step of classifying measured data into structured data or unstructured data for data framing by means of a data classifier;
a fourth step of searching for abnormal data or missing data by means of a data analyzer;
a fifth step of performing spatio-temporal analysis on measured data and performing interpolation on a missing data region through learning using an artificial intelligence model when data have a problem or are missing by means of a data learner;
a sixth step of constructing a database using interpolated data by means of a database unit; and
a seventh step of evaluating performance of the vessel by analyzing a local ice load, a global ice load, or ice performance using the database by means of a performance evaluator.

12. The integrated condition monitoring method of claim 11, wherein the data collector includes:
a 3-axis strain gauge sensor mounted on a parallel part of the bow and the hull of the vessel, and a frame and the internal plate of the hull in a stern area to measure a hull strain; and
an angular acceleration sensor being able to measure motion characteristics at a center of gravity of the hull, and
the 3-axis strain gauge sensor and the angular acceleration sensor measure a hull strain and motion characteristics of the vessel.

13. The integrated condition monitoring method of claim 12, wherein the data collector determines a sea ice concentration as an ice environment, analyzes the thickness of sea ice through an ice piece image rotated in ice breaking, and performs measurement by transmitting a trigger signal when the ice thickness is 30 cm or more and the concentration is 60% or more as the result of analysis.

14. The integrated condition monitoring method of claim 12, wherein when the trigger signal is transmitted, the data collector extracts information of a location and a speed of the vessel, a heading angle, a draft condition, engine power, a propeller revolution, and a propelling system angle, by cooperating with the voyage data recorder (VDR) and the alarm monitoring system (AMS).

15. The integrated condition monitoring method of claim 12, wherein the performance evaluator calculates the local ice load applied in a local area of the hull using an influence coefficient method on the basis of information of a hull strain in the hull in ice breaking, and calculates the global ice load applied to the vessel through motion analysis using motion characteristic measurement data of the vessel in ice breaking.

16. The integrated condition monitoring method of claim 12, wherein the performance evaluator extracts data for a predetermined period from one or more of a heading angle, a draft condition, engine power, a propeller revolution, and a propelling system angle through analysis of coefficient of variation (CV) on the basis of voyage information acquired from the information of the voyage data recorder (VDR) and the alarm monitoring system (AMS) of the vessel, and then calculates ice resistance applied to the vessel in ice breaking using Work-Energy Law and Newton's Second Law.

17. An integrated condition monitoring system for an ice-going vessel that is monitored by the integrated condition monitoring method of claim 11.

18. An integrated condition monitoring system for an ice-going vessel that is monitored by the integrated condition monitoring method of claim 12.

19. An integrated condition monitoring system for an ice-going vessel that is monitored by the integrated condition monitoring method of claim 13.

20. An integrated condition monitoring system for an ice-going vessel that is monitored by the integrated condition monitoring method of claim 14.

21. An integrated condition monitoring system for an ice-going vessel that is monitored by the integrated condition monitoring method of claim 15.

22. An integrated condition monitoring system for an ice-going vessel that is monitored by the integrated condition monitoring method of claim 16.
